(19) United States
(12) Patent Application Publication
(10) Pub. No.: US 2015/0356758 A1
(43) Pub. Date: Dec. 10, 2015

(54) IMAGE PROCESSING APPARATUS, IMAGE PROCESSING METHOD, AND NON-TRANSITORY COMPUTER READABLE MEDIUM

(71) Applicant: FUJI XEROX CO., LTD., Tokyo (JP)

(72) Inventor: Masafumi SUGAWARA, Kanagawa (JP)

(73) Assignee: FUJI XEROX CO., LTD., Tokyo (JP)

(21) Appl. No.: 14/556,739

(22) Filed: Dec. 1, 2014

(30) Foreign Application Priority Data
Jun. 5, 2014 (JP) 2014-116660

(51) Int. Cl. G06T 11/20; G06T 11/60

(52) U.S. Cl. CPC G06T 11/20; G06T 11/60; G06T 2207/20112

(57) ABSTRACT

An image processing apparatus includes a creation unit and a presentation unit. The creation unit adds up processing loads required to draw objects at each drawing position to calculate a value of the drawing position in order to generate a processing load image. The presentation unit visualizes the processing load image for presentation to a user.

### CROSS-REFERENCE TO RELATED APPLICATIONS

This application is based on and claims priority under 35 USC 119 from Japanese Patent Application No. 2014-116660 filed Jun. 5, 2014.

### BACKGROUND

1. (i) Technical Field

The present invention relates to an image processing apparatus, an image processing method, and a non-transitory computer readable medium.

2. (ii) Related Art

Documents and images to which various visual effects are added are capable of being created with simple operations in recent years, compared with those in related art. In output of the created documents or images, various drawing processes are performed to reproduce the added visual effects. As a result, the amount of processing is increased and the amount of data is also increased in the reproduction of the visual effects, compared with cases in which the visual effects are not used. In addition, various processing functions may be specified in the output of the created documents or images. The specification also increases the amount of processing, compared with cases in which no specification is made.

For example, a transparency effect is exemplified as one of the visual effects. When multiple graphics are overlaid on each other using the transparency effect, division-integration of the graphics occurs so that the amount of data is increased, compared with cases in which the transparency effect is not used, and the processing time is increased due to the increased drawing processes of the graphics, compared with the cases in which the transparency effect is not used. Such division-integration of the graphics is not intended by a user who has added the transparency effect and is internally performed in the processing. The user does not recognize the number of graphics and the number of layers resulting from the division-integration in the internal processing although the user recognizes the number of graphics to be drawn. For example, when it takes time to output a document or an image that is edited, the user may not recognize the reason for the time and the user only accepts the time required to output the target document or image.

The time required for the drawing processes becomes a problem with the progress of the performance of output apparatuses. For example, in the case of an image forming apparatus that forms images on cut sheets, an image of the next page is drawn no later than formation of an image of one page. If the drawing process is too late for the formation of the image, a delay may arise in the image formation not to provide the performance of the image forming apparatus. For example, in the case of an image forming apparatus that forms images on continuous sheets of paper, the drawing process that is too late may cause blank pages to be inserted into the continuous sheets of paper and it may be necessary to redo the image formation in units of roll paper or in units of the continuous sheets of paper.

### SUMMARY

According to an aspect of the invention, there is provided an image processing apparatus including a creation unit and a presentation unit. The creation unit adds up processing loads required to draw objects at each drawing position to calculate a value of the drawing position in order to generate a processing load image. The presentation unit visualizes the processing load image for presentation to a user.

### BRIEF DESCRIPTION OF THE DRAWINGS

Exemplary embodiments of the present invention will be described in detail based on the following figures, wherein:

FIG. 1 illustrates an exemplary configuration according to an exemplary embodiment of the present invention;

FIGS. 2A to 2D are diagrams for describing a first exemplary operation in an exemplary embodiment of the present invention;

FIG. 3 is a flowchart illustrating an exemplary process of the first exemplary operation in the present exemplary embodiment;

FIGS. 4A to 4C are diagrams for describing a second exemplary operation in an exemplary embodiment of the present invention;

FIG. 5 is a table for describing an example of processing load values corresponding to object types;

FIG. 6 is a flowchart illustrating an exemplary process of the second exemplary operation in the present exemplary embodiment;

FIGS. 7A to 7D are diagrams for describing a third exemplary operation in an exemplary embodiment of the present invention;

FIG. 8 is a table for describing an example of the processing load values corresponding to the types of processes to be applied to objects;

FIG. 9 is a flowchart illustrating an exemplary process of the third exemplary operation in the present exemplary embodiment;

FIGS. 10A to 10E are diagrams for describing a fourth exemplary operation in an exemplary embodiment of the present invention;

FIG. 11 is a flowchart illustrating an exemplary process of the fourth exemplary operation in the present exemplary embodiment;

FIG. 12 is a flowchart illustrating another exemplary process of the fourth exemplary operation in the present exemplary embodiment;

FIGS. 13A and 13B are diagrams for describing a fifth exemplary operation in an exemplary embodiment of the present invention;

FIG. 14 is a flowchart illustrating an exemplary process of the fifth exemplary operation in the present exemplary embodiment;

FIG. 15 is a flowchart illustrating another exemplary process of the fifth exemplary operation in the present exemplary embodiment; and

FIG. 16 is a diagram for describing an example of a computer program when functions described in the above exemplary embodiments are realized with the computer program, a storage medium storing the computer program, and a computer.

### DETAILED DESCRIPTION

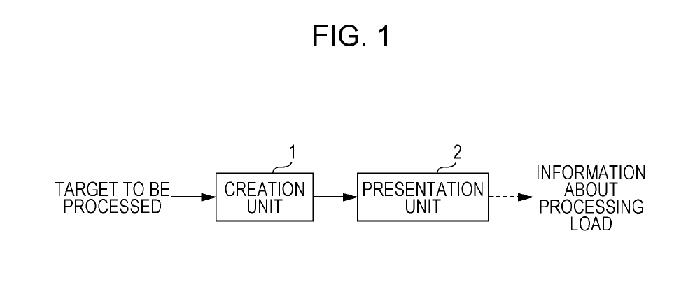

FIG. 1 illustrates an exemplary configuration according to an exemplary embodiment of the present invention. Referring to FIG. 1, the exemplary configuration includes a creation unit 1 and a presentation unit 2. Information to be processed may be any information, for example, may be various documents and images that are edited. The information to be processed includes at least one object to be drawn. For example, the information to be processed may be information described in a page description language (PDL) or information resulting from conversion of the information described in the page description language into an intermediate language used by an output apparatus.

In order to generate a processing load image, the creation unit 1 adds up processing loads required to draw the respective objects in the information to be processed at each drawing position. The processing loads of the objects may be uniformly set, may be set depending on the types of the objects, or may be set depending on the types of processes to be applied to the objects. In the addition of the processing loads of the respective objects at each drawing position, the processing loads are desirably added up on the basis of the overlap of the objects. The unit of the drawing position at which the processing load value is acquired may be one pixel in the output of the information to be processed, may be an area including multiple pixels, or may be a unit smaller than one pixel. Information in which the acquired values of the drawing positions are arranged is called the processing load image here.

In the creation unit 1, when the information to be processed is described in the intermediate language format, the processing load of the drawing process in the output apparatus is calculated at high accuracy compared with information described in other formats, because the intermediate language depends on the output apparatus.

When the objects corresponding to multiple pages are passed as the information to be processed, the processing load image is generated for every page. To calculate the processing load value of each page, the processing load values may be added up in a process to generate the processing load image or may be added up using the generated processing load image. Alternatively, the processing load value may be calculated for each document.

The presentation unit 2 visualizes the processing load image generated by the creation unit 1 for presentation to a user. For example, when the value at each drawing position in the processing load image is used as a density value and the processing load image is output as a monochrome image, different processing loads are presented with different densities. Alternatively, when the value at each drawing position in the processing load image is associated with a color value and the processing load image is output as a color image, different processing loads are presented with different colors. The drawn image may be processed in accordance with the processing load image to indirectly present the processing load image. The presentation to the user may be performed through various methods, such as a method of displaying the processing load image in a display apparatus or a method of forming the processing load image with an image forming apparatus.

When the processing load value of each page is calculated in the creation unit 1, the processing load value calculated in the creation unit 1 may be used to present information about the processing load of each page to the user. Switching between the information about the processing load of each page and the processing load image of each page may be enabled. If any page the processing load value of which is higher than a predetermined value exists, a warning is desirably presented to the user. When the processing load value is calculated for each document, the information about the processing load for each document may be presented to the user.

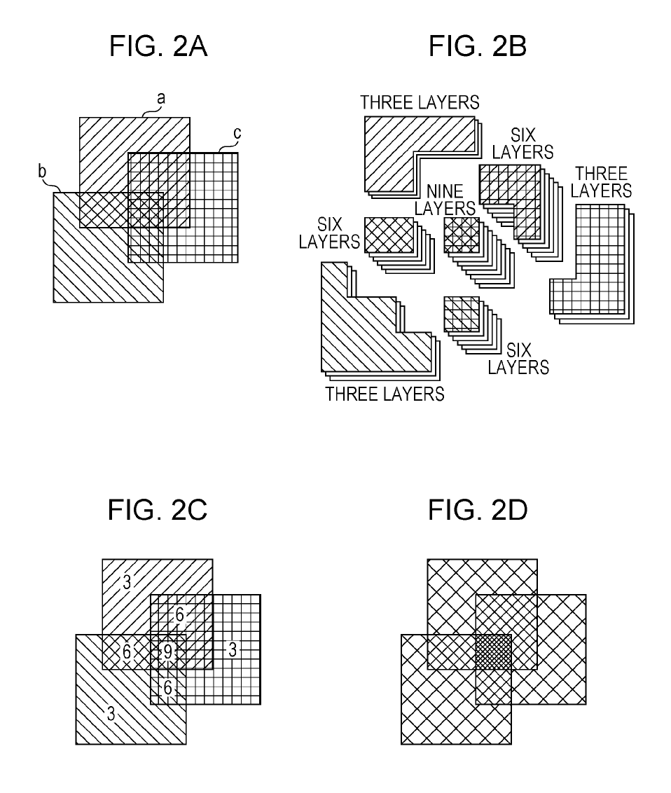

Exemplary operations in exemplary embodiments of the present invention will now be described with reference to specific examples. FIGS. 2A to 2D are diagrams for describing a first exemplary operation in an exemplary embodiment of the present invention. In the example in FIGS. 2A to 2D, the processing loads of the respective objects are added up on the basis of the overlap of the objects to generate the processing load image corresponding to one page. FIG. 2A illustrates exemplary objects to be drawn. In the example in FIG. 2A, three objects a, b, and c are drawn so as to be overlapped with each other. The transparency effect is added to the respective objects and the visual effect is reproduced in which the lower-layer objects, which are based on the degree of transparency that is set, are seen through. For example, the user may arrange the three objects for which the transparency effect is instructed, for example, using the degree of transparency so as to be overlapped with each other. In these figures, the objects are hatched and the transparency effect is represented with the overlap of the hatched lines for convenience.

In the drawing of such objects, the division-integration of the objects may occur. FIG. 2B illustrates an exemplary state in which the division-integration occurs. The example in FIG. 2B indicates a state in which each object is divided into three layers and the objects are divided on the basis of the overlapping state of the objects.

Simply provided that the value of the processing load caused by the drawing process of one layer is one, among the areas where the objects exist, an area where no overlap occurs has a processing load value of three because the drawing process of three layers is performed. An area where two objects are overlapped with each other has a processing load value of six because each object is divided into three layers and the drawing process of three layers is performed for the two objects to cause the drawing process of six layers. An area where three objects are overlapped with each other has a processing load value of nine because the drawing process of nine layers is performed. FIG. 2C illustrates these processing load values.

The creation unit 1 calculates the processing load value at each drawing position. In the above example, a processing load value Kl that is added up on the basis of the overlap of the objects is calculated according to the following equation:

Kl=n×m

where n denotes the number of layers into which one object is divided and m denotes the number of objects that are overlapped with each other. The processing load value Kl is calculated at each drawing position to provide information in which the processing load values Kl at the respective drawing positions are arranged. For example, in the example illustrated in FIG. 2A, the information illustrated in FIG. 2C is provided. This is used as the processing load image.

Upon generation of the processing load image in the creation unit 1, the presentation unit 2 visualizes the processing load image for presentation to the user. For example, each processing load value Kl of the processing load image may be directly used as the density value to present a monochrome gray-scaled image to the user. FIG. 2D illustrates an example of the monochrome gray-scaled image. Different densities are indicated with different hatched lines in the example in FIG. 2D for convenience.

The processing load value Kl of the processing load image may be subjected to a variety of processing. For example, the processing load value Kl of the processing load image may be weighted or may be subjected to normalization of the density. In the normalization, the range of the processing load value Kl may be converted into a range that is higher than or equal to a lower limit of the density and that is lower than or equal to an upper limit thereof. The processing load value Kl may be associated with a color to generate a color image for presentation to the user. The processing load values higher than a predetermined value may be visualized as the processing load image to emphasize the area where the higher processing load is applied. The processing load image may be overlapped with an image resulting from the drawing process or the processing load image and the image resulting from the drawing process may be arranged in a line for presentation to the user to allow the user to know which object the higher load is applied to for the processing. The image resulting from the drawing process may be processed using the processing load image to indirectly present the visualization of the processing load image using the image resulting from the drawing process. For example, the area the processing load value of which is higher than a predetermined value may be deleted or areas other than the above area may be deleted from the image resulting from the drawing process to allow the user to know the areas (objects) to which the higher loads are applied for the processing. The image presented to the user in this case may be generated by a masking process in which the image resulting from the drawing process is masked with the processing load image.

The state of the processing load is presented to the user in the above manner. The presentation of such an image to the user allows the user to visually recognize the state of the processing load, such as how much processing load is applied to which drawing area, when the user outputs the document or the image. For example, adopting measures, such as flattening to decrease the number of layers, for the document or the image visually determined to have the higher processing load reduces the processing load and the amount of data.

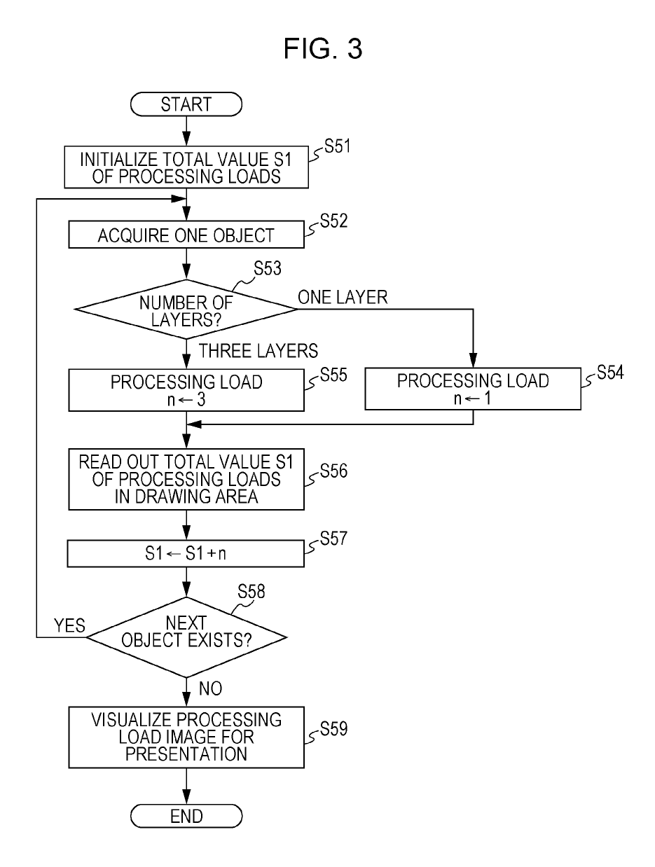

FIG. 3 is a flowchart illustrating an exemplary process of the first exemplary operation in the present exemplary embodiment. Referring to FIG. 3, in Step S51, a total value Sl of the processing loads corresponding to one image is initialized. In Step S52, one object is acquired. The object is to be processed in the following steps.

Although the three-layer processing is performed for each object in the specific examples described above, the number of layers to be processed may be varied depending on the object. For example, it is sufficient to perform one-layer processing in a filling process or the like, in which the transparency process is not performed. In the first exemplary operation, in Step S53, the number n of layers in the processing of the object is determined. Specifically, for example, if the number of layers is one, in Step S54, the processing load value is set to one. If the number of layers is three, in Step S55, the processing load value is set to three. The respective layers to be processed may be different objects depending on the format to be processed. In such a case, it is not necessary to perform the determination of the number of layers in Step S53.

In Step S56, the total value Sl of the processing loads corresponding to the drawing area of the object is read out. In Step S57, the processing load value (n) set in Step S54 or S55 is added to the total value Sl of the processing loads, which is read out, to set the result of the addition as the new total value Sl of the processing loads for the drawing area. In Step S58, it is determined whether the next unprocessed object exists. If the next unprocessed object exists (YES in Step S58), the process goes back to Step S52 to process the next unprocessed object. The repetition causes the processing load values (n) corresponding to the respective objects to be added up in the drawing area where multiple objects are overlapped with each other to calculate the processing load value Kl described above as the total value Sl of the processing loads.

If no unprocessed object remains in Step S58 (NO in Step S58), in Step S59, the presentation unit 2 reads out the total value Sl of the processing loads corresponding to one image generated in the above steps to generate the processing load image and visualizes the processing load image for presentation to the user. The processing in Step S59 generates, for example, the image illustrated in FIG. 2D. The user refers to the visualized image to determine the weight of the processing load.

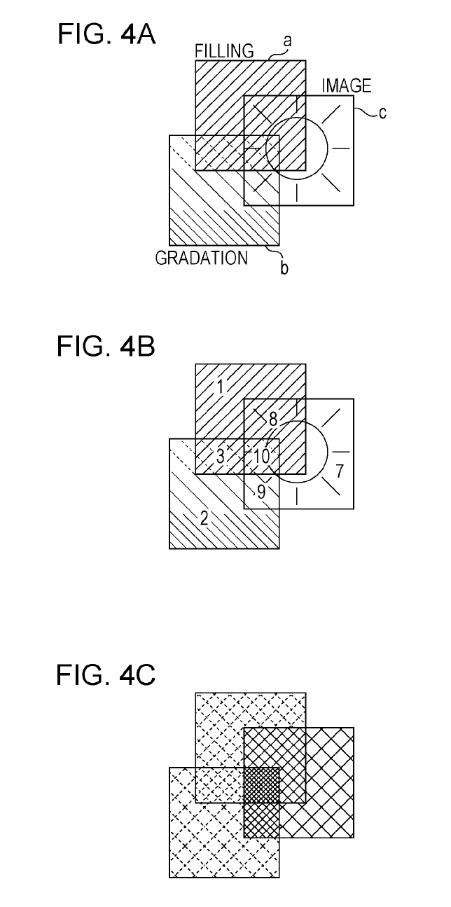

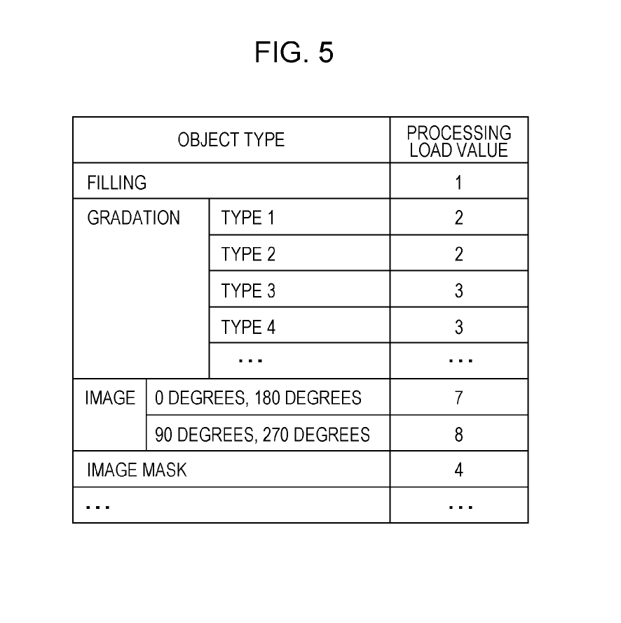

FIGS. 4A to 4C are diagrams for describing a second exemplary operation in an exemplary embodiment of the present invention. FIG. 5 is a table for describing an example of the processing load values corresponding to object types. An example will be described here in which the processing load of each object is set depending on the object type and the processing load values are added up on the basis of the overlap of the objects to generate the processing load image corresponding to one page. FIG. 4A illustrates exemplary objects to be drawn. In the example in FIG. 4A, three objects a, b, and c are drawn so as to be overlapped with each other. The object a has a filling type, the object b has a gradation type, and the object c has an image type. The types of the objects are illustrated in FIG. 4A.

In the drawing process of the objects, the processing load is varied depending on the object type. An example of the processing load values corresponding to object types is illustrated in FIG. 5. In the example illustrated in FIG. 5, the object type “filling” has a processing load value of one, the object type “gradation” has a processing load value of two or three, the object type “image” has a processing load value of seven or eight, and an object type “image mask” has a processing load value of four. Since the type of the object a is the filling in the example illustrated in FIG. 4A, the processing load value is equal to one. The type of the object b is the gradation and the processing load value of the object b is set to two here. The type of the object c is the image and the processing load value of the object c is set to seven here.

If the overlap occurs in the objects to be drawn, the division-integration of the objects or the like occurs or the drawing is performed multiple times in the overlapped area to make the processing load of the overlapped area higher than the processing loads of the other areas. Simply provided that the processing loads are added in the area where the overlap of the objects occurs, the processing loads illustrated in FIG. 4B are calculated. For example, the processing load value is equal to three in the drawing area where the object a is overlapped with the object b, the processing load value is equal to eight in the drawing area where the object a is overlapped with the object c, and the processing load value is equal to nine in the drawing area where the object b is overlapped with the object c. The processing load value is equal to ten in the drawing area where the object a, the object b, and the object c are overlapped with each other. The processing load values in the respective drawing areas are illustrated in FIG. 4B. The creation unit 1 calculates the processing load value at each drawing position to generate the processing load image.

The calculation corresponding to various conditions may be performed in the addition for the drawing areas where the objects are overlapped with each other. For example, weighted addition may be performed or various states including the overlapping order may be considered, instead of the simple addition of the processing load values.

Upon generation of the processing load image in the creation unit 1, the presentation unit 2 visualizes the processing load image for presentation to the user. The various methods described above in the first exemplary operation may be used for the presentation. For example, an example in which the processing load image is presented to the user using each processing load value of the processing load image as the density value is illustrated in FIG. 4C. Different densities are indicated with different hatched lines in the example in FIG. 4C for convenience. For example, the processing load value may be weighted or may be subjected to the normalization of the density. The processing load value may be associated with a color to generate a color image for presentation to the user. In addition, various methods may be used. For example, the processing load values higher than a predetermined value may be visualized as the processing load image, the processing load image may be overlapped with the image resulting from the drawing process or the processing load image and the image resulting from the drawing process may be arranged in a line for presentation to the user, or the image resulting from the drawing process may be processed using the processing load image to perform the indirect presentation. The user may visually determine the processing loads with reference to the image presented in the above manners to adopt measures. For example, the monochrome image or shading in which no change point of the color exists may be converted into the “filling process” or an image resulting from rotation by 90 degrees may be used after the image is rotated by 90 degrees in advance.

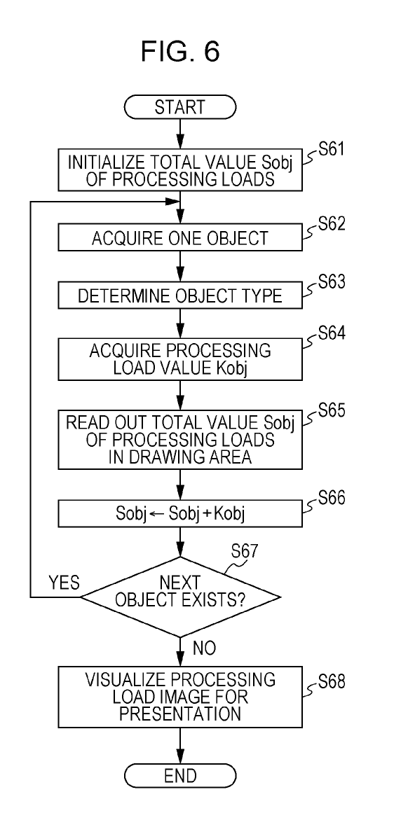

FIG. 6 is a flowchart illustrating an exemplary process of the second exemplary operation in the present exemplary embodiment. Referring to FIG. 6, in Step S61, a total value Sobj of the processing loads corresponding to one image is initialized. In Step S62, one object is acquired. The object is to be processed in the following steps.

In Step S63, the type of the object is determined. In Step S64, a processing load value Kobj corresponding to the object type is acquired.

In Step S65, the total value Sobj of the processing loads corresponding to the drawing area of the object is read out. In Step S66, the processing load value Kobj acquired in Step S64 is added to the total value Sobj of the processing loads, which is read out in Step S65, to set the result of the addition as the new total value Sobj of the processing loads for the drawing area. In Step S67, it is determined whether the next unprocessed object exists. If the next unprocessed object exists (YES in Step S67), the process goes back to Step S62 to process the next unprocessed object. The repetition causes the processing load values Kobj corresponding to the respective object types to be added up in the drawing area where multiple objects are overlapped with each other to calculate the total value Sobj of the processing loads.

If no unprocessed object remains in Step S67 (NO in Step S67), in Step S68, the presentation unit 2 reads out the total value Sobj of the processing loads corresponding to one image generated in the above steps to generate the processing load image and visualizes the processing load image for presentation to the user. The processing in Step S68 presents, for example, the image illustrated in FIG. 4C to the user. The user refers to the image to determine the weight of the processing load.

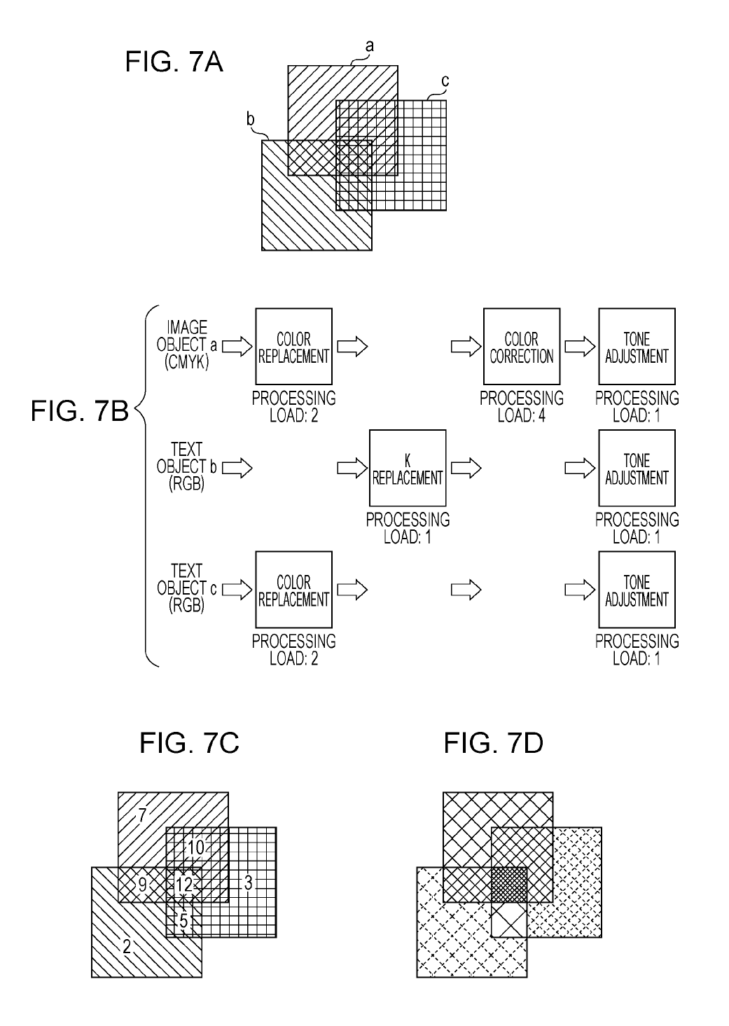

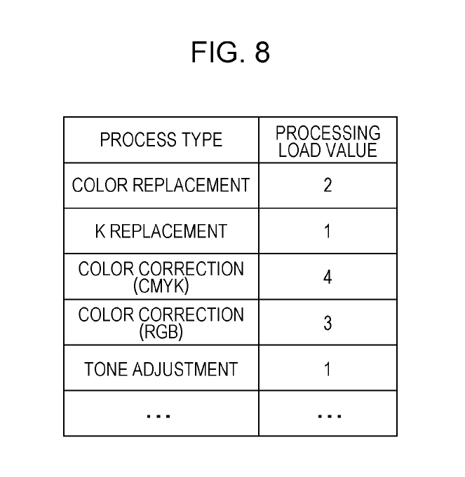

FIGS. 7A to 7D are diagrams for describing a third exemplary operation in an exemplary embodiment of the present invention. FIG. 8 is a table for describing an example of the processing load values corresponding to the types of processes to be applied to the objects. An example will be described here in which the processing load of each object is set depending on the type of the process to be applied to the object and the processing load values are added up on the basis of the overlap of the objects to generate the processing load image corresponding to one page. FIG. 7A illustrates exemplary objects to be drawn. In the example in FIG. 7A, three objects a, b, and c are drawn so as to be overlapped with each other. FIG. 7B illustrates processes to be applied to each object. A CMYK image is drawn for the object a and a color replacement process, a color correction process, and a tone adjustment process are applied to the object a. An RGB (R=G=B) text is drawn for the object b and a black (K) replacement process and the tone adjustment process are applied to the object b. An RGB (not R=G=B) text is drawn for the object c and the color replacement process and the tone adjustment process are applied to the object c.

In the drawing process of the objects, the processing load is varied depending on the type of the process to be applied to each object. An example of the processing load values corresponding to the respective process types to be applied to the objects is illustrated in FIG. 8. In the example illustrated in FIG. 8, for example, the processing load value is set to four in the color correction process of the CMYK, the processing load value is set to three in the color correction process of the RGB, the processing load value is set to two in the color replacement process, the processing load value is set to one in the black (K) replacement process, and the processing load value is set to one in the tone adjustment process.

In the example illustrated in FIG. 7B, since the processing load value for the color replacement process is two, the processing load value for the color correction process of the CMYK is four, and the processing load value for the tone adjustment process is one for the object a, the processing load value in the processing of the object a is seven. Since the processing load value for the black (K) replacement process is one and the processing load value for the tone adjustment process is one for the object b, the processing load value in the processing of the object b is two. Since the processing load value for the color replacement process is two and the processing load value for the tone adjustment process is one for the object c, the processing load value in the processing of the object c is three.

If the overlap occurs in the objects to be drawn, the division-integration of the objects or the like occurs or the drawing is performed multiple times in the overlapped area to make the processing load of the overlapped area higher than the processing loads of the other areas. Simply provided that the processing loads are added in the area where the overlap of the objects occurs, the processing loads illustrated in FIG. 7C are calculated. Specifically, the processing load value is equal to nine in the drawing area where the object a is overlapped with the object b, the processing load value is equal to ten in the drawing area where the object a is overlapped with the object c, and the processing load value is equal to five in the drawing area where the object b is overlapped with the object c. The processing load value is equal to 12 in the drawing area where the object a, the object b, and the object c are overlapped with each other. The processing load values in the respective drawing areas are illustrated in FIG. 7C. The creation unit 1 calculates the processing load value at each drawing position to generate the processing load image.

The calculation method may be devised in the calculation of the processing load value of each object from the processing load value corresponding to each process type. For example, the calculation may be performed in consideration of the process flow, instead of the simple addition. The calculation corresponding to various conditions may be performed in the addition also for the drawing areas where the objects are overlapped with each other. For example, the weighted addition may be performed or various states including the overlapping order may be considered, instead of the simple addition of the processing load values.

Upon generation of the processing load image in the creation unit 1, the presentation unit 2 visualizes the processing load image for presentation to the user. The various methods described above in the first exemplary operation may be used for the presentation. For example, an example in which the processing load image is presented to the user using each processing load value of the processing load image as the density value is illustrated in FIG. 7D. Different densities are indicated with different hatched lines in the example in FIG. 7D for convenience. Specifically, the processing load value may be weighted or may be subjected to the normalization of the density. The processing load value may be associated with a color to generate a color image for presentation to the user. In addition, various methods may be used. For example, the processing load values higher than a predetermined value may be visualized as the processing load image, the processing load image may be overlapped with the image resulting from the drawing process or the processing load image and the image resulting from the drawing process may be arranged in a line for presentation to the user, or the image resulting from the drawing process may be processed using the processing load image to perform the indirect presentation. The user may visually determine the processing loads with reference to the image presented in the above manners to adopt measures. For example, the setting of the process to be applied to the object may be varied to reduce the processing load.

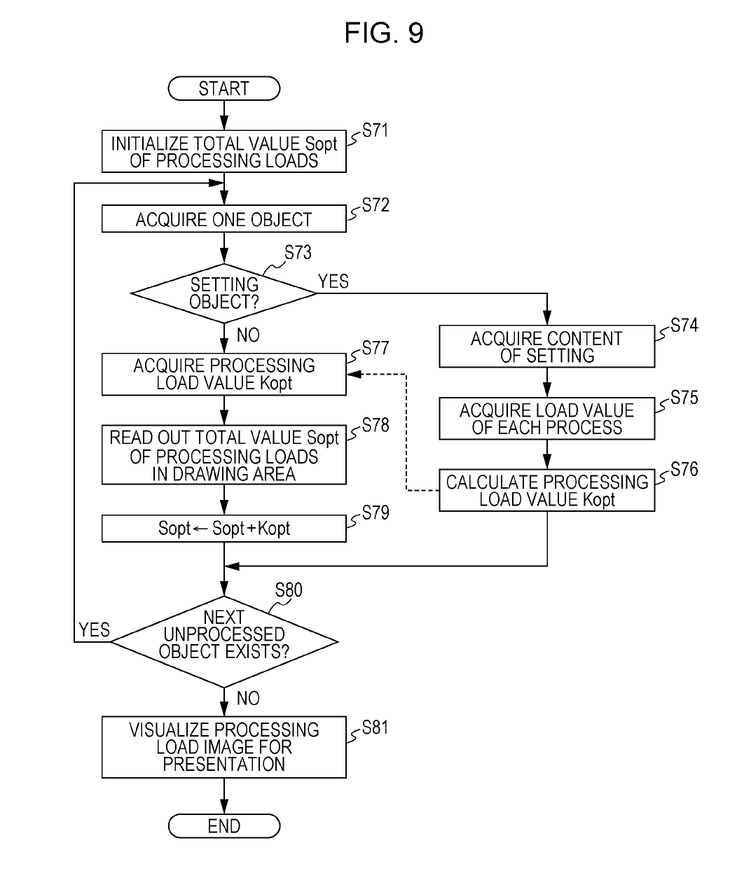

FIG. 9 is a flowchart illustrating an exemplary process of the third exemplary operation in the present exemplary embodiment. Referring to FIG. 9, in Step S71, a total value Sopt of the processing loads corresponding to one image is initialized. In Step S72, one object is acquired. The object is to be processed in the following steps.

In Step S73, it is determined whether the object to be processed is a setting object for which various settings are made. If the object to be processed is the setting object (YES in Step S73), in Step S74, the content of the setting made in the object is acquired. In Step S75, the value of the load of each process to be applied to the object to be drawn is acquired from the content of the setting acquired in Step S74 and the content of the previous settings. For example, the value of the load of each process may be acquired from the table of the processing load values illustrated in FIG. 8. In Step S76, a processing load value Kopt when the series of processes are performed is calculated from the value of the load of each process acquired in Step S75 and the processing load value Kopt is stored. In Step S80, it is determined whether the next unprocessed object exists. If the next unprocessed object exists (YES in Step S80), the process goes back to Step S72 to process the next unprocessed object.

If the object to be processed is not the setting object but is an object for which the drawing is performed in the determination in Step S73 (NO in Step S73), in Step S77, the processing load value Kopt stored in Step S76 is acquired. In Step S78, the total value Sopt of the processing loads corresponding to the drawing area of the object is read out. In Step S79, the processing load value Kopt acquired in Step S77 is added to the total value Sopt of the processing loads read out in Step S78 to set the result of the addition as the new total value Sopt of the processing loads for the drawing area. In Step S80, it is determined whether the next unprocessed object exists. If the next unprocessed object exists (YES in Step S80), the process goes back to Step S72 to process the next unprocessed object. The repetition causes the processing load values Kopt corresponding to the types of the processes to be applied to the objects to be added up in the drawing area where multiple objects are overlapped with each other to calculate the total value Sopt of the processing loads.

If no unprocessed object remains in Step S80 (NO in Step S80), in Step S81, the presentation unit 2 reads out the total value Sopt of the processing loads corresponding to one image generated in the above steps to generate the processing load image and visualizes the processing load image for presentation to the user. The processing in Step S81 presents, for example, the image illustrated in FIG. 7D to the user. The user refers to the image to determine the weight of the processing load.

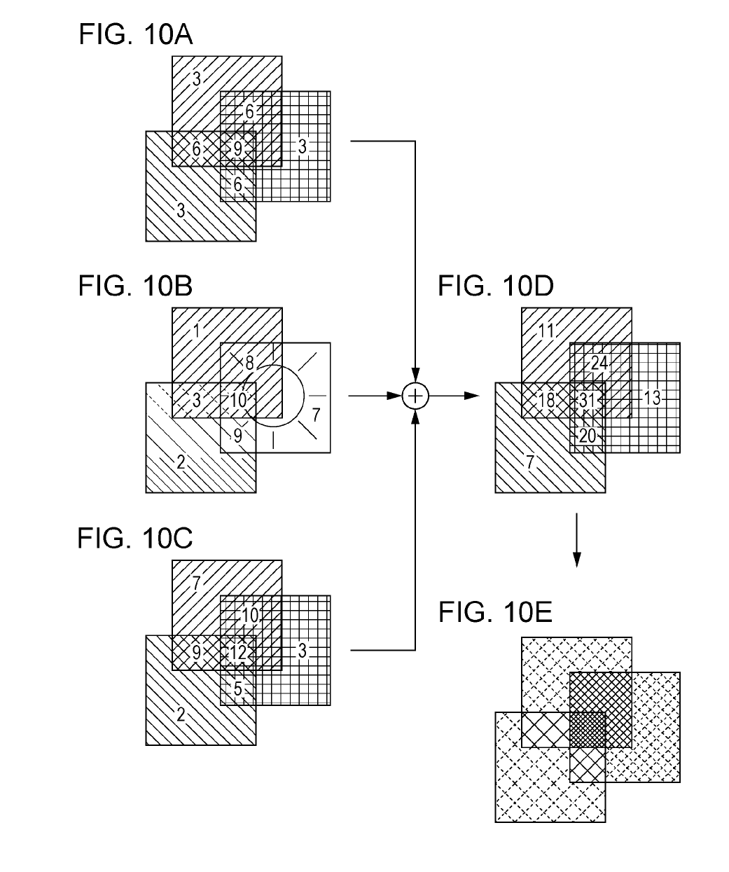

FIGS. 10A to 10E are diagrams for describing a fourth exemplary operation in an exemplary embodiment of the present invention. A combination of the methods of calculating the processing load described above in the first to third exemplary operations may be used to generate the processing load image corresponding to one page. An example is described in the fourth exemplary operation in which the processing loads acquired in the three methods described above are combined with each other.

FIG. 10A illustrates the exemplary processing load values acquired on the basis of the overlap of the objects, which are illustrated in FIG. 2C. FIG. 10B illustrates the exemplary processing load values acquired on the basis of the object types, which are illustrated in FIG. 4B. FIG. 10C illustrates the exemplary processing load values acquired on the basis of the types of the processes to be applied to the objects, which are illustrated in FIG. 7C.

The processing load values acquired with the above respective methods may be added up with a predetermined method to calculate the new processing load value. For example, FIG. 10D illustrates exemplary new processing load values resulting from the addition of the processing load values. Considering the acquired processing load values as pixel values provides the processing load image.

Upon generation of the processing load image in the creation unit 1, the presentation unit 2 visualizes the processing load image for presentation to the user. The various methods described above in the first exemplary operation may be used for the presentation. For example, an example in which the processing load image is presented to the user using each processing load value of the processing load image as the density value is illustrated in FIG. 10E. Different densities are indicated with different hatched lines in the example in FIG. 10E for convenience. Specifically, the processing load value may be weighted or may be subjected to the normalization of the density. The processing load value may be associated with a color to generate a color image for presentation to the user. In addition, various methods may be used. For example, the processing load values higher than a predetermined value may be visualized as the processing load image, the processing load image may be overlapped with the image resulting from the drawing process or the processing load image and the image resulting from the drawing process may be arranged in a line for presentation to the user, or the image resulting from the drawing process may be processed using the processing load image to perform the indirect presentation. The user may visually determine the processing loads with reference to the image presented in the above manners to adopt measures.

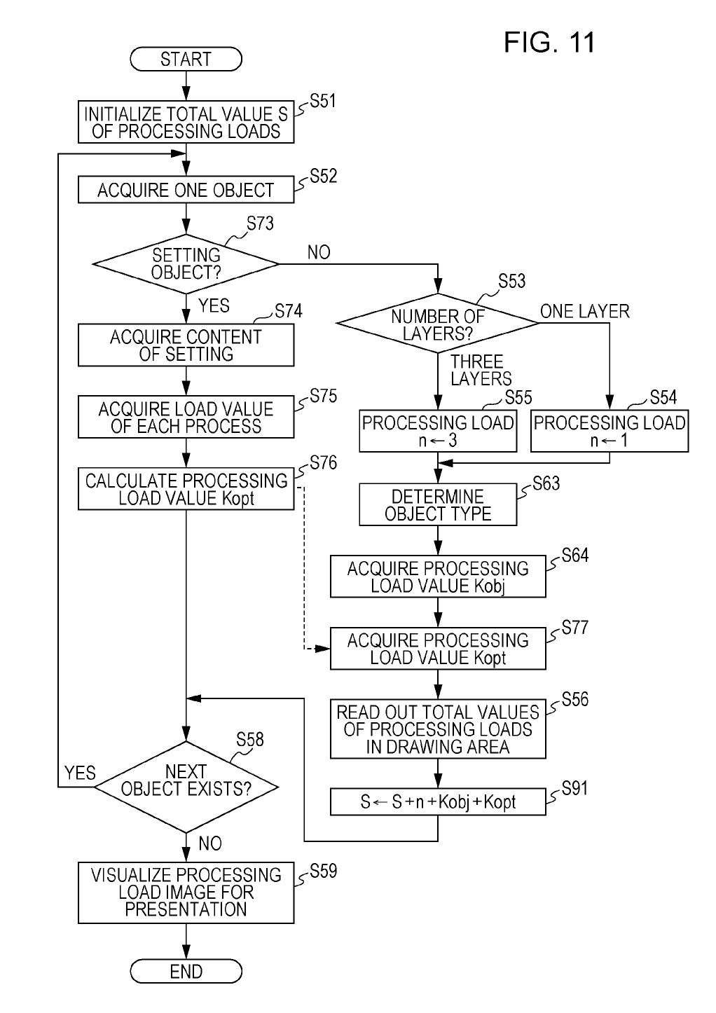

FIG. 11 is a flowchart illustrating an exemplary process of the fourth exemplary operation in the present exemplary embodiment. The exemplary process illustrated in FIG. 11 results from combination of the first exemplary operation illustrated in FIG. 3, the second exemplary operation illustrated in FIG. 6, and the third exemplary operation illustrated in FIG. 9.

Referring to FIG. 11, in Step S51, a total value S of the processing loads corresponding to one image is initialized. In Step S52, one object is acquired. The object is to be processed in the following steps.

In Step S73, it is determined whether the object to be processed is the setting object for which various settings are made. If the object to be processed is the setting object (YES in Step S73), in Step S74, the content of the setting made in the object is acquired. In Step S75, the value of the load of each process to be applied to the object to be drawn is acquired from the content of the setting acquired in Step S74 and the content of the previous settings. In Step S76, the processing load value Kopt when the series of processes are performed is calculated from the value of the load of each process acquired in Step S75 and the processing load value Kopt is stored. In Step S58, it is determined whether the next unprocessed object exists. If the next unprocessed object exists (YES in Step S58), the process goes back to Step S52 to process the next unprocessed object.

If the object to be processed is not the setting object but is an object for which the drawing is performed in the determination in Step S73 (NO in Step S73), in Step S53, the number n of layers in the processing of the object is determined. Specifically, for example, if the number of layers is one, in Step S54, the processing load value when the number of layers is one is set. If the number of layers is three, in Step S55, the processing load value when the number of layers is three is set. In the fourth exemplary operation, the processing load value is set to one in Step S54 and the processing load value is set to three in Step S55.

In Step S63, the type of the object is determined. In Step S64, the processing load value Kobj corresponding to the object type is acquired. In Step S77, the processing load value Kopt stored in Step S76 is acquired. In Step S56, the total value S of the processing loads corresponding to the drawing area of the object is read out. In Step S91, the processing load value (n) set in Step S54 or S55, the processing load value Kobj acquired in Step S64, and the processing load value Kopt acquired in Step S77 are added to the total value S of the processing loads read out in Step S56 to set the result of the addition as the new total value S of the processing loads for the drawing area.

In Step S58, it is determined whether the next unprocessed object exists. If the next unprocessed object exists (YES in Step S58), the process goes back to Step S52 to process the next unprocessed object. The repetition causes the processing loads on the basis of the overlap of the objects, the processing loads corresponding to the object types, and the processing loads corresponding to the types of the processes to be applied to the objects to be added up in the drawing area where multiple objects are overlapped with each other to calculate the total value S of the processing loads.

If no unprocessed object remains in Step S58 (NO in Step S58), in Step S59, the presentation unit 2 reads out the total value S of the processing loads corresponding to one image generated in the above steps to generate the processing load image and visualizes the processing load image for presentation to the user. The processing in Step S59 presents, for example, the image illustrated in FIG. 10E to the user. The user refers to the image to determine the weight of the processing load.

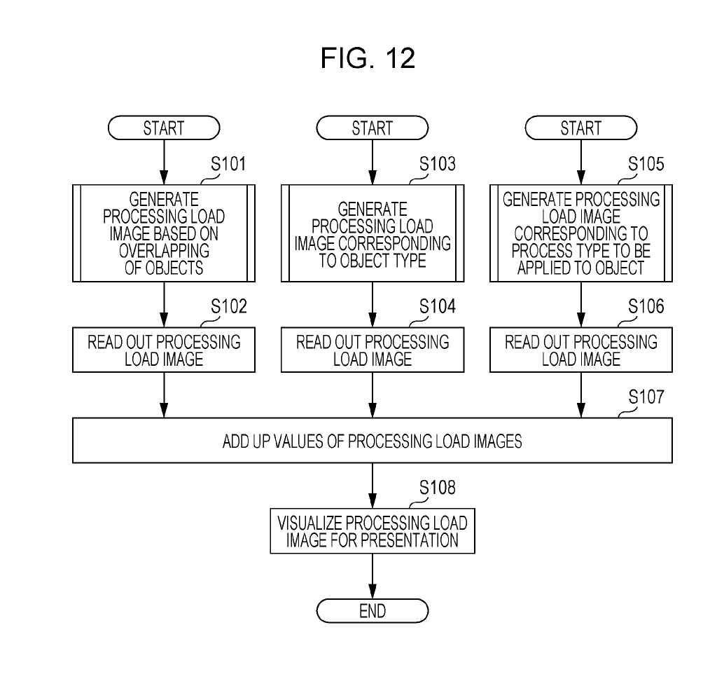

FIG. 12 is a flowchart illustrating another exemplary process of the fourth exemplary operation in the present exemplary embodiment. An example is indicated in FIG. 12 in which the processing load image composed of the processing load values based on the overlap of the objects, the processing load image composed of the processing load values corresponding to the object types, and the processing load image composed of the processing loads values corresponding to the types of the processes to be applied to the object, which are separately generated, are combined with each other to use the combined image as the processing load image to be presented to the user.

Referring to FIG. 12, in Step S101, the process excluding Step S59 in the first exemplary operation illustrated in FIG. 3 is performed to generate the processing load image based on the overlap of the objects. In Step S103, the process excluding Step S68 in the second exemplary operation illustrated in FIG. 6 is performed to generate the processing load image corresponding to the object type. In Step S105, the process excluding Step S81 in the third exemplary operation illustrated in FIG. 9 is performed to generate the processing load image corresponding to the type of the process to be applied to the object.

In Step S102, the processing load image generated in Step S101 is read out. In Step S104, the processing load image generated in Step S103 is read out. In Step S106, the processing load image generated in Step S105 is read out. In Step S107, the values of the processing load images read out in Steps S102, S104, and S106 are added up to acquire the new processing load value, thereby generating the new processing load image.

In Step S108, the presentation unit 2 visualizes the processing load image generated in Step S107 for presentation to the user. For example, the image illustrated in FIG. 10E is presented to the user. The user refers to the image to determine the weight of the processing load.

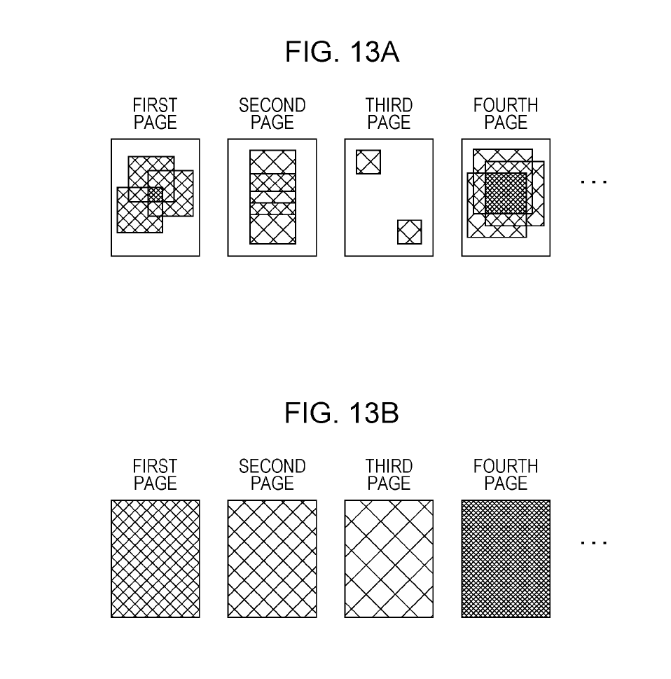

FIGS. 13A and 13B are diagrams for describing a fifth exemplary operation in an exemplary embodiment of the present invention. The example is indicated in the exemplary operations described above in which the processing load image corresponding to one page is generated for presentation to the user. For example, when multiple pages are output, the processing load is varied depending on the image of each page. An example is indicated in the fifth exemplary operation in which the processing load value of each page is calculated for presentation to the user.

FIG. 13A illustrates an example in which the processing load images of the respective pages generated in the creation unit 1 or images resulting from reduction in size of the processing load images of the respective pages are arranged in a line for presentation to the user. The difference on the image caused by different processing loads is indicated with different hatched lines in the example in FIG. 13A for convenience. The processing load image of each page may be generated with the various methods described above in the first exemplary operation and the generated processing load image may be reduced in size. For example, each processing load value of the processing load image may be represented as a density value to generate a gray-scaled image or each processing load value of the processing load image may be associated with a color value to generate a color image and the gray-scaled image or the color image may be reduced in size. The processing load value may be weighted or may be subjected to the normalization of the density. The processing load values higher than a predetermined value may be visualized as the processing load image. The image resulting from the drawing process may be reduced in size and the reduced image resulting from the drawing process may be overlapped with the reduced processing load image or the reduced processing load image and the reduced image resulting from the drawing process may be arranged in a line for presentation to the user. The reduced image resulting from the drawing process may be processed using the reduced processing load image to perform the indirect presentation. For example, the processing load image before the reduction in size may be presented in response to an instruction to identify a page from the user in a state in which the image resulting from the reduction in size of the processing load image is presented.

FIG. 13B illustrates an example in which the processing load value of each page is calculated in the creation unit 1 and the processing load value is visualized for presentation to the user. Different processing load values in different pages are indicated with different hatched lines also in the example in FIG. 13B for convenience. The processing load value of each page may be calculated as, for example, the average of the processing load values composing the processing load image. Alternatively, the processing load values composing the processing load image are added up to use the result of the addition as the processing load value of each page. Alternatively, the processing loads are added up also for the processing load value of each page in the process of generating the processing load image to acquire the result of the addition. When the total value is used as the processing load value of each page, the distribution (areas) of the processing load values is reflected.

In order to visualize the information about the processing load of each page for presentation to the user, any of the above methods used for the presentation of the processing load image may be used. For example, the processing load value of each page may be used as the density value to output a monochrome image or the processing load value of each value may be associated with a color value to output a color image. Different densities or different colors are indicated with different hatched lines in the example in FIG. 13B for convenience. Also in this case, the pages the processing load values of which are higher than a predetermined value may be gray-scaled or colored for presentation to the user. The image resulting from the drawing process may be reduced in size to be overlapped with the processing load image of each image or the processing load image and the image resulting from the drawing process may be separately reduced in size and the reduced processing load image and the reduced image resulting from the drawing process may be arranged in a line for presentation to the user. Alternatively, the image resulting from the drawing process may be processed using the processing load image and the processed image may be reduced in size or the reduced image resulting from the drawing process may be processed using the reduced processing load image to perform the indirect presentation.

Also in this case, in response to an instruction to identify a page from the user, the processing load image of the identified page may be presented.

Upon presentation of the processing load of each page illustrated in FIG. 13A or 13B, the user may determine the weight of the processing load of each page to adopt measures. If any page the processing load value of which is higher than a predetermined value exists, a warning may be presented to the user. In this case, the state of the processing load of each page is determined independently of the subjective view of the user. In the determination of the predetermined value used as a threshold value, the processing load value with which the drawing is completed in a time to be in time for continuous output may be set as an upper limit in, for example, an image forming apparatus that outputs a drawn image. In this case, the warning is presented to the user if any page for which the continuous output is not performed in the image forming apparatus exists.

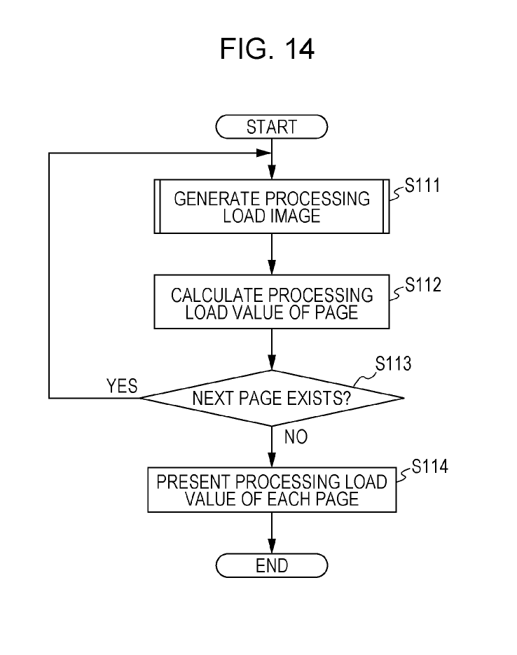

FIG. 14 is a flowchart illustrating an exemplary process of the fifth exemplary operation in the present exemplary embodiment. An example is indicated in this exemplary operation in which the processing load value of each page is calculated, as in the example illustrated in FIG. 13B.

Referring to FIG. 14, in Step S111, the processing load image corresponding to one page is generated. For example, any of the processes until the processing load image is generated in the respective exemplary operations illustrated in FIG. 3, FIG. 6, FIG. 9, FIG. 11, and FIG. 12 may be performed.

In Step S112, the processing load value of the corresponding page is calculated on the basis of the processing load image. For example, the average of the processing load values composing the processing load image may be calculated. Alternatively, the processing load values composing the processing load image may be added up to use the result of the addition as the processing load value of each page. The processing load value of each page may be subjected to a variety of processing. For example, the processing load value of each page may be normalized so as to be within a predetermined range.

In Step S113, it is determined whether the next page exists. If the next page exists (YES in Step S113), the process goes back to Step S111 to process the next page. If the next page does not exist (NO in Step S113), in Step S114, the information about the processing load of each page is visualized on the basis of the processing load value calculated for each page for presentation to the user. If any page the processing load value of which is higher than a predetermined value exists, the warning may be presented to the user. The user receives the information about the processing load of each page or the warning, which is presented, to adopt measures.

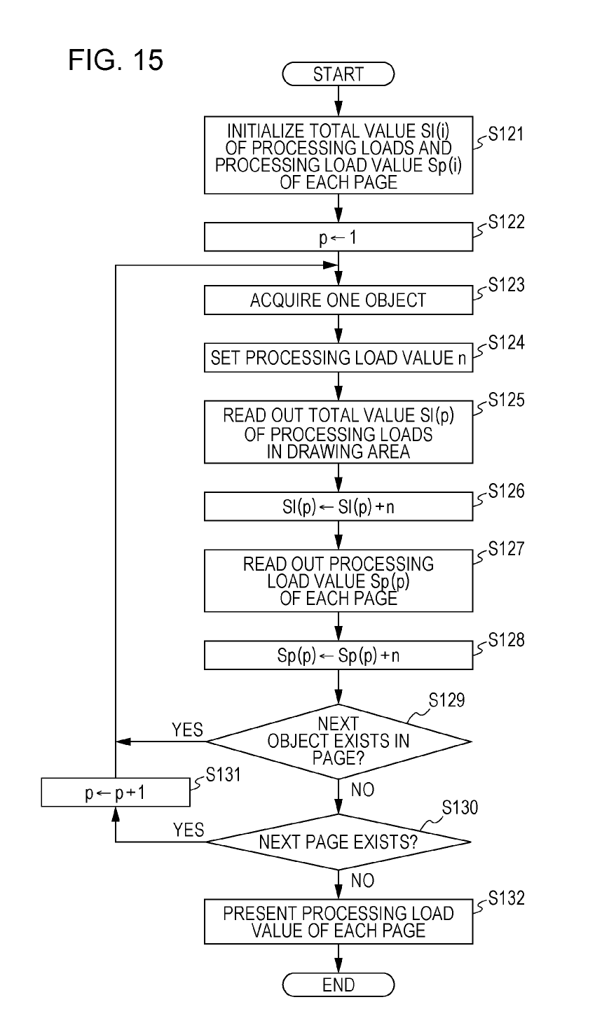

FIG. 15 is a flowchart illustrating another exemplary process of the fifth exemplary operation in the present exemplary embodiment. The processing load value of each page is calculated in the exemplary operation illustrated in FIG. 15, as in the example illustrated in FIG. 13B. However, the processing load value of each page is calculated along with the processing load image in the exemplary operation illustrated in FIG. 15. An example is indicated in the exemplary operation in FIG. 15 in which the processing load values of the respective pages are calculated in parallel on the basis of the example in which the processing loads of the respective objects are added up on the basis of the overlap of the objects, which is indicated as the first exemplary operation.

Referring to FIG. 15, in Step S121, a total value Sl(i) of the processing loads corresponding to multiple pages is initialized and a processing load value Sp(i) of each page is initialized. Here, i denotes the number of pages and i=1, . . . , max (the maximum page number). In Step S122, a variable p indicating the page to be processed is initialized to one. This indicates that the first page is to be processed.

In Step S123, one object is acquired. In Step S124, a processing load value n when the object acquired in Step S123 is drawn is set. For example, the processing load value n corresponding to the number of layers is set in Step S54 or Step S55 in the exemplary process illustrated in FIG. 3. Similar setting may be performed here.

In Step S125, a total value Sl(p) of the processing loads corresponding to the drawing area of the object is read out. In Step S126, the processing load value n set in Step S124 is added to the total value Sl(p) of the processing loads, which is read out, to set the result of the addition as the new total value Sl(p) of the processing loads for the drawing area. In Step S127, a processing load value Sp(p) of each page is read out. In Step S128, the processing load value n set in Step S124 is added to the processing load value Sp(p) of each page, which is read out, to set the result of the addition as the new processing load value Sp(p) of each page for the drawing area.

In Step S129, it is determined whether the next unprocessed object exists in the page. If the next unprocessed object exists in the page (YES in Step S129), the process goes back to Step S123 to process the next unprocessed object. The repetition causes the processing load value n corresponding to each object to be added to the total value Sl(p) of the processing loads and also to be added to the processing load value Sp(p) of each page in the drawing area where multiple objects are overlapped with each other.

If it is determined that no unprocessed object exists in the page (NO in Step S129), in Step S130, it is determined whether the next page exists. If the next page exists (YES in Step S130), in Step S131, the variable p indicating the page number is incremented by one. Then, the process goes back to Step S123 to process the next page.

If it is determined that no next page exists (NO in Step S130), in Step S132, the presentation unit 2 reads out the processing load value Sp(i) of each page, which is generated in the above steps, and visualizes the processing load value Sp(i) of each page for presentation to the user. For example, the information about the processing loads illustrated in FIG. 13B may be presented to the user. If any page the processing load value of which is higher than a predetermined value exists, the warning may be presented to the user. When the user issues an instruction to identify a page, the processing load image of the identified page may be presented. The user may determine the weight of the processing load from the presented information.

When the information about the processing load of each page is only presented to the user, the calculation of the total value Sl(p) of the processing loads in Step S125 and Step S126 may not be performed. The addition may be performed or the average may be calculated on the basis of the processing load value of each page to calculate the processing load value of each document and the processing load value of each document may be visualized for presentation to the user.

Although the modified example is indicated in the exemplary operation illustrated in FIG. 15 in which the processing load value of each page is calculated on the basis of the process in which the processing load value based on the overlap of the objects is used in the first exemplary operation illustrated in FIG. 3, the exemplary operation illustrated in FIG. 15 is not limited to this. For example, the exemplary operation illustrated in FIG. 15 may be modified so that the processing load value of each page is calculated on the basis of the process in which the processing load value corresponding to the object type is used in the second exemplary operation illustrated in FIG. 6, the process in which the processing load value corresponding to the type of the process to be applied to the object is used in the third exemplary operation illustrated in FIG. 9, or the process in which the multiple processing load values are used in the fourth exemplary operation illustrated in FIG. 11 and FIG. 12.

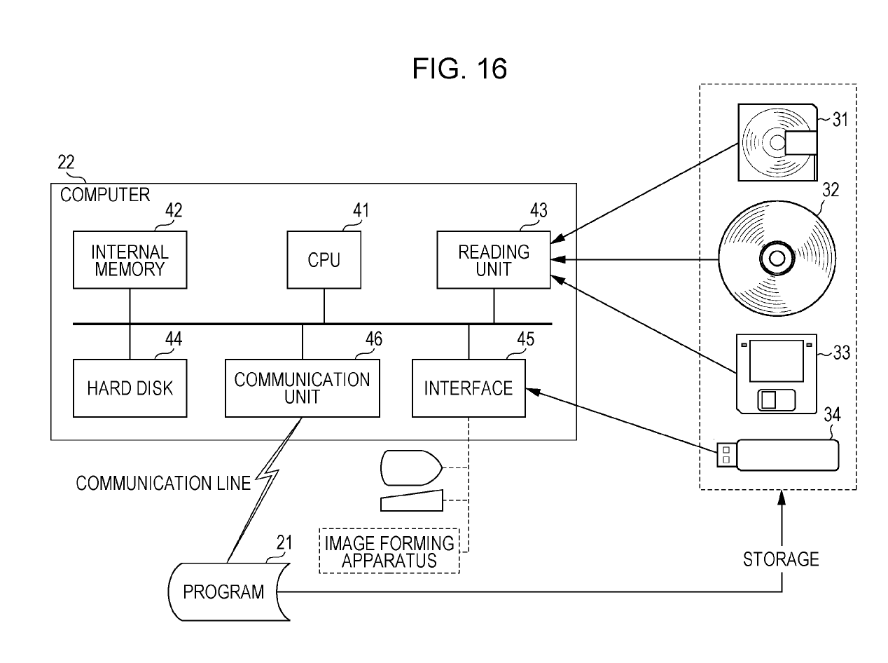

FIG. 16 is a diagram for describing an example of a computer program when the functions described in the above exemplary embodiments are realized with the computer program, a storage medium storing the computer program, and a computer. Referring to FIG. 16, reference numeral 21 denotes a program, reference numeral 22 denotes a computer, reference numeral 31 denotes a magneto-optical disk, reference numeral 32 denotes an optical disk, reference numeral 33 denotes a magnetic disk, reference numeral 34 denotes a memory, reference numeral 41 denotes a central processing unit (CPU), reference numeral 42 denotes an internal memory, reference numeral 43 denotes a reading unit, reference numeral 44 denotes a hard disk, reference numeral 45 denotes an interface, and reference numeral 46 denotes a communication unit.

All or part of the functions described above in the exemplary embodiments may be realized by the program 21 executed by the computer. In this case, the program 21 and data used by the program 21 may be stored in the storage medium from which the program 21 and the data are read out by the computer. The storage medium causes a state in which energy such as magnetism, light, or electricity is varied in accordance with the content of description of the program for the reading unit 43 provided in the hardware resource of the computer to transmit the content of description of the program to the reading unit 43 in the signal format corresponding to the varied energy state. The storage medium is, for example, the magneto-optical disk 31, the optical disk 32 (including a compact disc (CD) and a digital versatile disk (DVD)), the magnetic disk 33, or the memory 34 (including an integrated circuit (IC) card, a memory card, and a flash memory). The storage medium is not limited to the portable type.

The program 21 is stored in the storage medium, the storage medium is loaded in, for example, the reading unit 43 or the interface 45 in the computer 22 to read out the program 21 from the computer 22, the program 21 is stored in the internal memory 42 or the hard disk 44 (including a magnetic disk and a silicon disk), and the program 21 is executed by the CPU 41 to realize all or part of the functions described above in the exemplary embodiments. Alternatively, the program 21 may be transferred to the computer 22 via a communication line, the program 21 may be received by the communication unit 46 in the computer 22 to be stored in the internal memory 42 or the hard disk 44, and the program 21 may be executed by the CPU 41 to realize all or part of the functions described above in the exemplary embodiments.

Various apparatuses may be connected to the computer 22 via the interface 45. For example, a display apparatus used by the presentation unit 2 to present the information about the processing load to the user may be connected to the computer 22 via the interface 45. A receiving unit that receives specification of a page from the user in the presentation of the processing load image of the specific page in the information about the processing load of each page may be connected to the computer 22 via the interface 45. An image forming apparatus that practically draws information to be processed to form an image may be connected to the computer 22 via the interface 45. Other various apparatuses may be connected to the computer 22 via the interface 45.

The above components may be partially composed of the hardware or all of the above components may be composed of the hardware. Alternatively, the above components may be composed as the program including all or part of the functions described above in the exemplary embodiments along with other components. When the above components are applied to other applications, the above components may be integrated with the programs in the applications. The components may not necessarily be operated in one computer and the processing may be executed by different computers depending on the processing stages.

The foregoing description of the exemplary embodiments of the present invention has been provided for the purposes of illustration and description. It is not intended to be exhaustive or to limit the invention to the precise forms disclosed. Obviously, many modifications and variations will be apparent to practitioners skilled in the art. The embodiments were chosen and described in order to best explain the principles of the invention and its practical applications, thereby enabling others skilled in the art to understand the invention for various embodiments and with the various modifications as are suited to the particular use contemplated. It is intended that the scope of the invention be defined by the following claims and their equivalents.

What is claimed is:

1. An image processing apparatus comprising:
a creation unit that adds up processing loads required to draw objects at each drawing position to calculate a value of the drawing position in order to generate a processing load image; and
a presentation unit that visualizes the processing load image for presentation to a user.

2. The image processing apparatus according to claim 1,
wherein the creation unit adds up processing load values required to draw objects based on overlap of the objects to calculate the value of the drawing position in order to generate the processing load image.

3. The image processing apparatus according to claim 1,
wherein the creation unit sets processing load values required to draw objects depending on object types and adds up the processing load values based on the overlap of the objects to calculate the value of the drawing position in order to generate the processing load image.

4. The image processing apparatus according to claim 2,
wherein the creation unit sets processing load values required to draw objects depending on object types and adds up the processing load values based on the overlap of the objects to calculate the value of the drawing position in order to generate the processing load image.

5. The image processing apparatus according to claim 1,
wherein the creation unit sets processing load values required to draw objects depending on types of processes to be applied to the objects and adds up the processing load values based on the overlap of the objects to calculate the value of the drawing position in order to generate the processing load image.

6. The image processing apparatus according to claim 1,
wherein the creation unit further adds up processing load values of each page, and
wherein the presentation unit presents information about the processing load of each page to the user.

7. The image processing apparatus according to claim 6,
wherein the presentation unit presents a warning to the user if any page the processing load value of which is higher than a predetermined value exists.

8. A non-transitory computer readable medium storing a program causing a computer to execute a process comprising:
adding up processing loads required to draw objects at each drawing position to calculate a value of the drawing position in order to generate a processing load image; and
visualizing the processing load image for presentation to a user.

9. An image processing method comprising:
adding up processing loads required to draw objects at each drawing position to calculate a value of the drawing position in order to generate a processing load image; and
visualizing the processing load image for presentation to a user.
